(19) United States
(12) Patent Application Publication
(10) Pub. No.: US 2023/0205618 A1
(43) Pub. Date: Jun. 29, 2023

(54) PERFORMING ROOT CAUSE ANALYSIS ON DATA CENTER INCIDENTS

(71) Applicant: Microsoft Technology Licensing, LLC, Redmond, WA (US)

(72) Inventor: Xinjian XUE, Bothell, WA (US)

(21) Appl. No.: 17/565,426

(22) Filed: Dec. 29, 2021

(51) Int. Cl. G06F 11/07

(52) U.S. Cl. CPC G06F 11/079; G06F 11/0709

(57) ABSTRACT

Described herein are technologies pertaining to identifying and applying association rules in connection with identifying a root cause of a problem in a computing system. The association rules are constrained such that one side of the association rules is unidimensional. Upon an incident report being received, association rules that are relevant to the incident report are identified and ranked, where a top threshold number of association rules is employed to identify a potential root cause of an incident represented by the incident report.

### BACKGROUND

Performing root cause analysis with respect to incidents reported by a cloud computing system (e.g., in a data center that supports Software as a Service (SaaS), Platform as a Service (PaaS), storage as a service, etc.) is a difficult computational task, as a cloud computing system may include hundreds of thousands to millions of different, unique components, and an incident report may identify anywhere between one and thousands of components that correspond to an incident in the cloud computing system (e.g., where an incident may be a service disruption, a service slow down, or the like). Components of a cloud computing system include software and hardware computing components, as well as sensors that report statutes of one or more components in the cloud computing system. The components may be included in a core layer, an aggregation layer, and/or an access layer of the cloud computing system, where each of these layers includes different components.

For instance, the core layer provides a high-speed packet switching backplane for data flows going in and out of a data center of the cloud computing system. The core layer provides connectivity to multiple aggregation components, runs an interior routing protocol, and load balances traffic between different components of the data center. Components in the aggregation layer provide functions such as service module integration, domain definitions, spanning tree processing, default gateway redundancy, etc. Aggregation layer components may also provide services such as content switching, firewall, SSL offload, intrusion detection, network analysis, etc.

The access layer is where servers physically attach to a network. Server components in the access layer can include blade servers with integral switches, blade servers with pass-through cabling, clustered servers, mainframes, etc. Infrastructure of the access layer can include modular switches, integral blade server switches, etc. Components of all of these layers additionally include software components. Hence, it can be ascertained that a cloud computing system includes hundreds of thousands to millions of different components, some of which depend upon one another for proper functioning. Due to the large number of components, and co-dependencies between components, when an incident report is received, it is difficult to identify which component or set of components is the root cause of an incident represented in an incident report.

Conventional approaches for performing root cause analysis in a cloud computing system are either labor-intensive or computationally intensive. For example, the incident report can be provided to an engineer, and the engineer, based upon prior experience, checks on components that the engineer believes may be the root cause of an incident represented in the incident report. In another example, machine learning techniques have been employed in connection with identifying root causes of incidents in cloud computing systems. In these conventional machine learning techniques, however, a significant amount of training data must be collected, and training a deep neural network (DNN) is computationally expensive. Further, a machine learning model may become at least partially obsolete when components in the cloud computing environment are updated or changed, and the training process must be repeated.

### SUMMARY

The following is a brief summary of subject matter that is described in greater detail herein. This summary is not intended to be limiting as to the scope of the claims.

Described herein are various technologies relating to identifying a root cause of an incident represented in an incident report generated by a cloud computing system, where the incident may be a service disruption (for a specific service), a service slow down, or the like. With more particularly, association rule mining (ARM) is employed to identify association rules based upon components identified in incident reports generated by the cloud computing system over time, where the association rules are generated in a computationally-efficient manner. Each of the association rules includes a left-hand side (LHS) and a right-hand side (RHS), where items in the LHS of an association rule are mapped to a single item in the RHS of the association rule. With more particularity with respect to ARM, ARM is a rule-based machine learning method for discovering patterns in large data sets. For instance, there is a set l of n distinct items in a data set T of m transactions, where each transaction includes between two and n different items. Association rules are generated by, for each transaction, partitioning items into disjoint sets X and Y. An association rule based upon a transaction partitioned into disjoint sets X and Y is defined as a pattern that indicates that X, Y appears together with some frequency in T. When identifying association rules is constrained to the items in l being distinct and comparable, and Y being unidimensional, association rules can be identified in a computationally efficient manner.

More specifically, for a data set T that includes a relatively large number of transactions, where each transaction can potentially include a large number of items (where items represent components in a cloud computing system), all association rules represented in T, where Y is unidimensional, can be identified in P-time, which is a drastic improvement in computational efficiency over when Y may be multidimensional. Accordingly, for a large data set, thousands of association rules can be generated in a computationally efficient manner.

When an incident report is received, the association rules are searched based upon components identified in the incident report. Association rules that have items in a LHS (X) of the rules that at least partially overlap with items that represent components identified in the incident report are returned as potential association rules that may identify a root cause of an incident represented in the incident report. Identified association rules may then be ranked based upon values for a suitable metric corresponding to the association rules, where example metrics include, but are not limited to, confidence, support, lift, and conviction. In another example, a metric referred to herein as “relevance” for an association rule (based upon overlap between items in the LHS of the association rule and components identified in the incident report) can be computed and utilized in determining which of the association rules to identify and/or to position the identified association rules in a ranked list of association rules.

In response to identifying and ranking association rules based upon an incident report, a top threshold number of association rules are selected. In an example, the top threshold number of association rules are used to identify components that are potential root causes of the incident referenced in the incident report. For instance, identities of the component(s) are provided to an engineer in the cloud computing system, and the engineer inspects such components. In another example, identities of the components are provided to the cloud computing system, and such components are restarted automatically by the cloud computing system. Therefore, a root cause of an incident can be identified and addressed more quickly when compared to conventional approaches.

The technologies described herein exhibits various advantages over conventional approaches for performing root cause analysis with respect to components of a cloud computing system referenced in an incident report. Specifically, by mandating that Y (one of the disjoint sets created based upon items in a transaction) is unidimensional, association rules can be identified from a relatively large data set in a computationally-efficient manner (P-time). Further, all association rules represented in the data can be identified, rather than having to heuristically choose cutoffs to save computing resources. Moreover, a machine learned model need not be trained and executed to surface potential root causes of incident reports.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an example computing system that is configured to generate and apply association rules with respect to incident reports corresponding to a cloud computing system.

FIGS. 2 and 3 are schematics that illustrate operation of an association rules identifier system.

FIG. 4 is a schematic that illustrates identifying and ranking association rules upon receipt of an incident report that includes multiple items that represent components of a cloud computing system.

FIG. 5 is a plot that depicts distribution of association rules based upon size of the left-hand side (LHS) of the association rules.

FIG. 6 is a plot that illustrates a distribution of confidence scores of association rules.

FIG. 7 is a plot that illustrates an observed relationship between confidence and lift scores for association rules.

FIG. 8 is a plot that illustrates an observed relationship between confidence and conviction scores for association rules.

FIG. 9 is a flow diagram illustrating an example method for identifying association rules from a database of transactions.

FIG. 10 is a flow diagram illustrating an example method for identifying and applying one or more association rules upon receipt of an incident report that corresponds to a cloud computing environment.

FIG. 11 is an example computing system.

### DETAILED DESCRIPTION

Various technologies pertaining to performing root cause analysis with respect to an incident represented in an incident report generated by a cloud computing system are now described with reference to the drawings, where like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “system”, and “module” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something and is not intended to indicate a preference.

Various technologies pertaining to performing root cause analysis with respect to an incident represented in an incident report generated by a cloud computing system are described herein. As will be described in greater detail below, a database includes several transactions, where the transactions are representative of incident reports generated by the cloud computing system. Each transaction includes multiple items that are representative of components of the cloud computing system that are reporting information related to an incident that is captured in the incident report (where, for example, the incident is a service disruption, a service slowdown, or the like). The database may include thousands of such transactions, and transactions may include between two and tens of thousands of items. The technologies described herein include generating association rules based upon the transactions in the database, where each association rule includes a left-hand side (LHS) that comprises at least one item and a right-hand side (RHS) that has a single item. Put differently, each association rule maps one or more items to a respective single item. As will be described herein, the association rules are generated in a computationally-efficient manner (e.g., in P-time).

Once the association rules are generated, such rules can be employed in connection with identifying root causes corresponding to incident reports generated by the cloud computing system. For example, the cloud computing system emits an incident report, where the incident report includes identifiers of components of the cloud computing system that correspond to the incident. The association rules are searched based upon the components identified in the incident report, such that association rules having items in the LHS of such rules that at least partially overlap with items that represent identified components in the incident report are retrieved. The retrieved association rules are ranked based upon values computed for the association rules, where the values correspond to a metric, and further where the metric can be one or more of confidence, support, live, conviction, etc. In another example, the metric is relevance, which is indicative of an amount of overlap between items in the LHS of the rules and items that represent identified components in the incident report. Identities of components of the cloud computing system represented by items in the RHS of a threshold number of the most highly ranked association rules can be returned to a computing device operated by an engineer, who can then investigate the identified components to ascertain whether one or more of such components is the root cause of the incident represented in the incident report.

While the technologies described herein are set forth with respect to incident reports generated by cloud computing systems, such technologies can also be employed in other contexts where recommendations are to be presented. For example, the technologies described herein can be employed to predict a next webpage that will be visited by a user given some previous set of visited webpages. In another example, the technologies described herein are well suited to predict an item that will be purchased by a user given previous items purchased by the user.

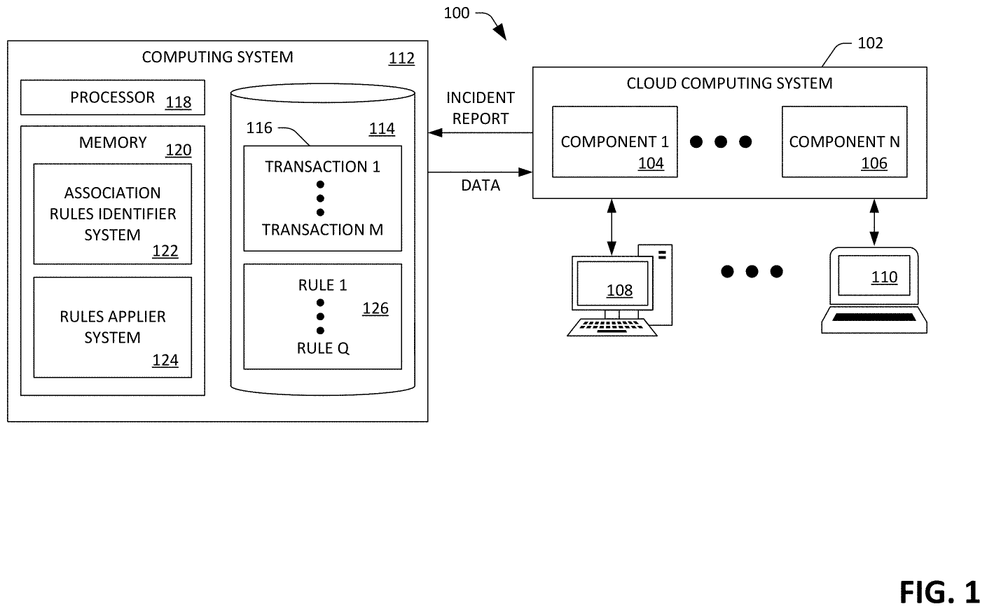

With reference now to FIG. 1, a functional block diagram of an example system 100 is illustrated, where the system 100 is configured to generate association rules and subsequently employ one or more generated association rules in connection with identifying a root cause of an incident represented in an incident report generated by a cloud computing system. The system 100 includes a cloud computing system 102, where the cloud computing system 102 comprises several components 104-106. The cloud computing system 102 may include thousands to millions of different components, where the components 104-106 include hardware components, software components, sensors, etc. For instance, one or more of the components 104-106 is a computing device, and one or more of the components 104-106 may be a software thread that is executing on such computing device. The cloud computing system 102 may include one or more data centers, and thus may include components typically found in such data centers. In still another example, the components 104-106 include a blade server, a thread executing on the blade server, an edge router, a network connection, a load balancer, etc.

Numerous computing devices 108-110 are in communication with the cloud computing system 102 by way of a network or networks. For example, the cloud computing system 102 offers one or more services, and the computing devices 108-110 access the cloud computing system 102 in connection with being provided the services.

When an incident occurs in the cloud computing system 102, one or more computing devices of the cloud computing system 102 is configured to generate an incident report that is representative of an incident in the cloud computing system 102. An incident can be a service disruption, a service slowdown, etc. The incident report includes several items that are representative of components from amongst the components 104-106 associated with the incident represented in the incident report. For instance, when a service provided by the cloud computing system 102 is detected as being slow, the incident report identifies the service and components amongst the components 104-106 that are associated with the service and/or that are reporting an error at the time of occurrence of the incident. Over time, the cloud computing system 102 may generate numerous incident reports (on the order of tens of thousands to millions of incident reports), where each incident report includes identifiers of numerous components that are associated with an incident.

The system 100 additionally includes a computing system 112 that is in communication with the cloud computing system 102 and receives incident reports generated by the cloud computing system 102. The computing system 112 includes a data store 114, where the data store 114 comprises a database of transactions 116, where the transactions respectively correspond to incident reports generated by the cloud computing system 102. Therefore, each transaction in the database of transactions 116 is representative of an incident report generated by the cloud computing system 102. Each of the transactions in the database 116 includes numerous items that are representative of components from amongst the components 104-106 identified in an incident report.

The computing system 112 further includes a processor 118 and memory 120, where the processor 118 executes instructions that are stored in the memory 120. The memory 120 includes an association rules identifier system 122 and a rules applier system 124, where such systems 122 and 124 will be described in greater detail below. Briefly, the association rules identifier system 122 generates association rules 126 based upon the transactions in the database 116. The association rules identifier system 122 obtains a transaction from the database 116, where the transaction includes several items that are not duplicative with respect one another. The association rules identifier system 122 then creates several pairs of disjoint sets of items, where one disjoint set in each pair of disjoint sets is unidimensional (e.g., one disjoint set in each pair includes a single item). The number of pairs of disjoint sets created for a transaction is equivalent to the number of items in the transaction.

The association rules identifier system 122 generates the association rules 126 based upon the pairs of disjoint sets. More specifically, the association rules identifier system 122 generates an association rule for each unique pair of disjoint sets created based upon the transactions in the database 116. Each association rule in the association rules 126 includes a left-hand side (LHS) and a right-hand side (RHS), where the LHS of each association rule includes one or more items and the RHS of each association rule is unidimensional (e.g., includes a single item), where the association rule maps the one or more items in the RHS to the single item in the LHS (e.g., a set of items that comprises item(s) in the LHS of an association rule is also somewhat likely to include the item in the RHS of the association rule). As will be described in greater detail herein, because the RHS of each of the association rules 126 is unidimensional, the association rules identifier system 122 can generate the rules 126 in a computationally-efficient manner (e.g., in P-time), which is an improvement over conventional approaches for generating association rules based upon transactions that may include numerous items.

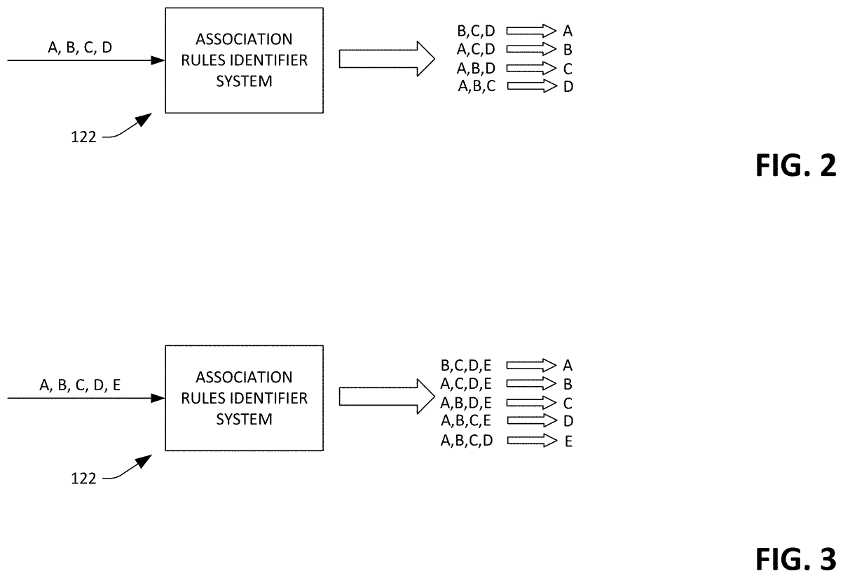

Referring briefly to FIG. 2, a schematic that illustrates operation of the association rules identifier system 122 is illustrated. In the example shown in FIG. 2, the association rules identifier system 122 receives a transaction from the database 116 that includes items A, B, C, and D. The association rules identifier system 122 generates four different pairs of disjoint sets of items, where these pairs include [A, BCD], [B, ACD], [C, ABD], and [D, ABC]. It is again noted that in each pair of disjoint sets, one set in a pair includes a single item. From these pairs of disjoint sets, the association rules identifier system 122 generates four association rules: 1) B,C,D→A; 2) A,C,D→B; 3) A,B,D→C; and 4) A,B,C→D.

Referring to FIG. 3, another schematic illustrating operation of the association rules identifier system 122 is illustrated. In the example illustrated in FIG. 3, the association rules identifier system 122 receives a transaction from the database 116 that includes the items A, B, C, D, and E. Based upon the transaction, the association rules identifier system 122 creates five pairs of disjoint sets of items, where each pair includes one set that is unidimensional. More specifically, the association rules identifier system 122 generates the following pairs of disjoint sets: [A, BCDE], [B, ACDE], [C, ABDE], [D, ABCE], and [E, ABCD]. From these five pairs of disjoint sets of items, the association rules identifier system 122 generates five association rules, where the RHS of each of the Association rules is unidimensional (as illustrated in FIG. 3).

Returning to FIG. 1, when a new incident report is generated by the cloud computing system 102, the rules applier system 124 identifies rules that correspond to the incident represented in the incident report, where the rules applier system 124 identifies the rules based upon components of the cloud computing system 102 represented in the received incident report. The rules applier system 124 further ranks the identified rules based upon values assigned to the rules, where the values are for at least one metric. With more specificity, the rules applier system 124 receives the incident report, which includes identifiers for components from amongst the components 104-106 of the cloud computing system 102 that are associated with an incident represented by the incident report. The rules applier system 124 searches the rules 126 based upon the identifiers for the components included in the incident report, and identifies rules based upon such identifiers in the incident report. For example, the rules applier system 124 identifies each rule that has items in the LHS of the rule that at least partially overlap with items represented in the incident report. The rules applier system 124 may then rank the identified rules based upon values assigned to such rules, where a value assigned to a rule may be for a metric such as confidence, support, lift, conviction, and/or relevance (where relevance is described in greater detail below).

The rules applier system 124 may then select a top threshold number of rules from the ranked list of rules and, based upon the selected rules, transmit data to a computing device associated with the cloud computing system 102. The data may identify components represented on the RHS of the selected rules, such that an engineer that is provided with such data can check the identified components in the cloud computing system 102 to ascertain whether such components (alone or in combination) are the root cause of the incident represented by the incident report. In another example, the data transmitted to the cloud computing system 102 causes the identified components to be restarted in connection with addressing the root cause of the incident referenced in the incident report.

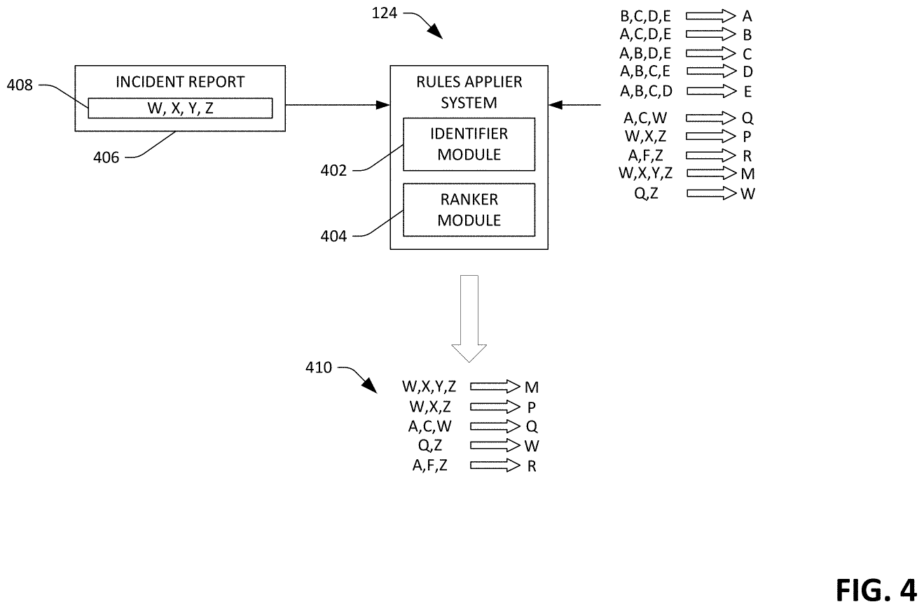

Referring now to FIG. 4, a schematic that illustrates operation of the rules applier system 124 is depicted. The rules applier system 124 includes an identifier module 402 and a ranker module 404. The identifier module 402 identifies rules from the rules 126 that are potentially relevant to an incident report generated by the cloud computing system 102. The ranker module 404 ranks the rules identified by the identifier module 402 based upon values assigned to such rules, wherein the values are for one or more metrics.

In the example shown in FIG. 4, the rules applier system 124 receives an incident report 406 that includes a set of items 408 that represent components of the cloud computing system 102, where the items are W, X, Y, and Z. The identifier module 402 searches the LHS of each rule in the rules 126 for overlap between the items 408 and items in the LHS of the rules.

As shown, the identifier module 402 identifies five association rules 410 from the rules 126. The identifier module 402 identifies the rules 410 due to items in the LHS of the rules 410 at least partially overlapping with the items 408 in the incident report 406. For instance, the identifier model 402 identifies a first rule due to the items 408 in the incident report 406 exactly matching the items in the LHS of the first rule (W,X,Y, Z). In another example, the identifier module 402 identifies a second rule (W, X, Z→P) due to W, X, and Z in the LHS of the second rule being included amongst the items 408 in the incident report 406. In yet another example, the identifier module 402 identifies a third rule from the rules 126 based upon the third rule including the item W (along with A and C) in the LHS of the third rule, where W is also included in the items 408 in the incident report 406. It can be ascertained that the rules 126 may include several thousand rules when the database 116 has a large number of transactions, and thus for a received incident report, the identifier module 402 may identify a relatively large number of rules.

The ranker module 404 ranks the rules identified by the identifier module 402 based upon values assigned to such rules. As indicated previously, and as described in greater detail below, values for confidence, support, lift, conviction, and/or relevance can be computed for rules in the identified set of rules 410, and the ranker module 404 ranks rules in the rules 410 based upon one or more of the values for such metrics. The rules applier system 124 may then select a most highly ranked top threshold number (e.g., five) of rules from the identified rules based upon the ranking of the association rules performed by the ranker model 404.

Additional detail pertaining to operation of the association rules identifier system 122 and the rules applier system 124 is now set forth. Association rule mining (ARM) performed by the association rules identifier system 122 is a rules-based machine learning method for discovering intersecting patterns in large data sets, such as the database of transactions 116. Given a set l of n distinct items (e.g., the components 104-106) and a data set T (the database of transactions 116) of m transactions, where each of the transactions includes 2 to n different items, the association rules identifier system 122 can partition the items in a transaction into two disjoint sets X and Y. An association rule identified by the association rules identifier system 122 indicates that certain X, Y appear together with some frequency in T. Identifying all association rules represented in the database 116 (where an association rule is denoted as X→Y) is an NP hard problem, meaning that it is difficult to identify all the association rules within a reasonable amount of time and through use of a reasonable amount of computing resources.

When the association rules identifier system 122 identifies association rules with the constraints that the RHS of each of the rules is unidimensional and that items in 1 are distinct and comparable, then the association rules identifier system 122 can identify all association rules represented in the database 116 in P-time. More precisely, the data set T includes transactions T₁, . . . Tₘ, with each transaction including two or more items from a distinct item set l. The association rules identifier system 122 can be configured to identify all patterns present in the transactions included in the database 116 given the constraints that the items in l are distinct and comparable and the RHS of the rules is unidimensional. The association rules identifier system 122 can partition items in a transaction Tᵢ into two disjoint sets Xᵢ and Yᵢ. The two disjoint sets Xᵢ and Yᵢ are considered as an association rule Xᵢ→Yᵢ when the following two conditions hold true:
1. The pattern Xᵢ∪Yᵢ appears in T frequently enough, measured by the support s(Xᵢ∪Yᵢ)=|Xᵢ∪Yᵢ|/|T|=|Xᵢ∪Yᵢ|/m≥s. Here, 0<s≤l is a constant and called the minimum support; and
2. The confidence of rule Xᵢ⇒Yᵢ, measured by c(Xᵢ⇒Yᵢ)=s(Xᵢ∪Yᵢ)/s(Xᵢ)≥c. Here, 0<c≤l is a constant and called the minimum confidence. Confidence is an estimation of conditional probability of P(E_{Y}_{ᵢ}|E_{X}_{ᵢ})
   When Y is constrained to be unidimensional, the problem is simplified in the following manner. A discrete item set l=l₁, . . . lₙ, and a data set T has transactions T₁, . . . , Tₘ=X₁∪y₁ . . . Xₘ∪yₘ, where Xᵢ contains 1 to n−1 items from l, Yᵢ contains exactly one item from l, and Xᵢ∩Yᵢ=∅. Discovery of all association rules X→Y is the identification of all patterns, such as Xⱼ→Yⱼ, satisfying the following:

s(Xⱼ|yⱼ)=|Xᵢ∪yᵢ|/m>0. (1)

c(Xⱼ⇒yⱼ)=s(Xⱼ∪yⱼ)/s(Xⱼ)>0. (2)

With open-zero as the minimums of support and confidence, the association rules identifier system 122 can identify all association rules represented in the database 116, including those low probability rules that may have disproportional importance in some applications, in P-time. In an example, the association rules identifier system 122 trims rules from the rule set based upon needs of a particular application that may emphasize certain items in input or output, or size of the resultant rule set.

The association rules identifier system 122 can identify all rules represented in the transactions 116 in P-time when the item set l is discrete and comparable and the RHS of each rule is unidimensional. Further, the association rules identifier system 122 can compute support for all yᵢ given the constraints referenced above. This can be accomplished by representing all yᵢ with strings and performing a GROUP operation on such strings, resulting in worst time-complexity of O(m log m).

Since all items in each Xᵢ are discrete and comparable, the items can be sorted and represented with strings. After such conversion, the association rules identifier system 122 can identify all patterns in the transactions database 116 through use of the nested GROUP-ing operations with an unchanged worst time complexity of O(m log m). After such step, the association rules identifier system 122 has grouped the transactions into patterns per items in LHS and RHS, where each pattern is a tuple (Xᵢ, Yᵢ).

The association rules identifier system 122 can calculate support for Xᵢ by determining whether Xᵢ⊂Yⱼ for all i≠j. Each such test, if Xᵢ⊂Xⱼ, can be performed by the association rules identifier system 122 by way of a SET operation with worst time complexity of O(n²). The association rules identifier system 122 performs such test m² times at most, and thus the worst time complexity is O(m·log m·n²). The m×m SET operation poses challenges to time and space capacities in calculation. To avoid two-dimensional space requirements, or if cross-join is not allowed, the association rules identifier system 122 can convert the cross-join to an inner-join on a pseudo join key:
X extend dummy=1
X join kind=inner X on dummy
   Since the association rules identifier system 122 has computed support of X and y, as well as the confidence of X→y, the association rules identifier system 122 can compute two other widely used measurements, lift and conviction. Lift is related to the dependence of the LHS and RHS and is defined as follows:

l(Xᵢ⇒yᵢ)=s(Xᵢ∪yᵢ)/[s(Xᵢ)s(yᵢ)]=c(Xⱼ⇒yⱼ)/s(yᵢ) (3)

Conviction is related to the implication of LHS and RHS and can be written as follows:

v(Xᵢ⇒yᵢ)=[1−s(yᵢ)]/[1−c(Xⱼ⇒yⱼ)] (4)

Based upon the foregoing, it can be ascertained that under the assumptions that the item set includes n discrete and comparable items, the database 116 includes m transactions, and the RHS is unidimensional, then the association rules identifier system 122 can compute the full association rule set X→y in worst-case time complexity O(m log mn²), thus in P-time.

With reference now to the rules applier system 124, and referring again to FIG. 4, once the full rule set X→y is obtained, the rules applier system 124 can receive a previously unseen input X_{α}. The identifier module 402 identifies rules where Xᵢ fully or partially matches X_{α}. Pursuant to an example, the identifier module 402 and ranker module 404 compute a measure of closeness of input X_{α} to Xᵢ, referred to herein as relevance, as follows:

Relevance r(X_{α}, Xᵢ)=|X_{α}∩Xᵢ|/|X_{α}|, 0≤r≤1 (5)

In an example, the identifier module 402 computes a relevance value for a rule and determines whether the rule is to be returned based upon the relevance value. The ranker module 404 can employ relevance, confidence (or lift, support, and/or conviction) to order the rules identified by the identifier module 402 and select k of such rules to predict the outcome, namely y_{α}.

The association rules identifier system 122 and the rules applier system 124 were tested on a public cloud computing system, where the database 116 included 1.2 million transactions (incidents), with item set of a size 2,650. In the test, the association rules identifier system 122 identified 4,837 distinct X with lengths from 1 to 404 and 2,008 distinct y. The identified X and y resulted in identification of 9,555 separate rules.

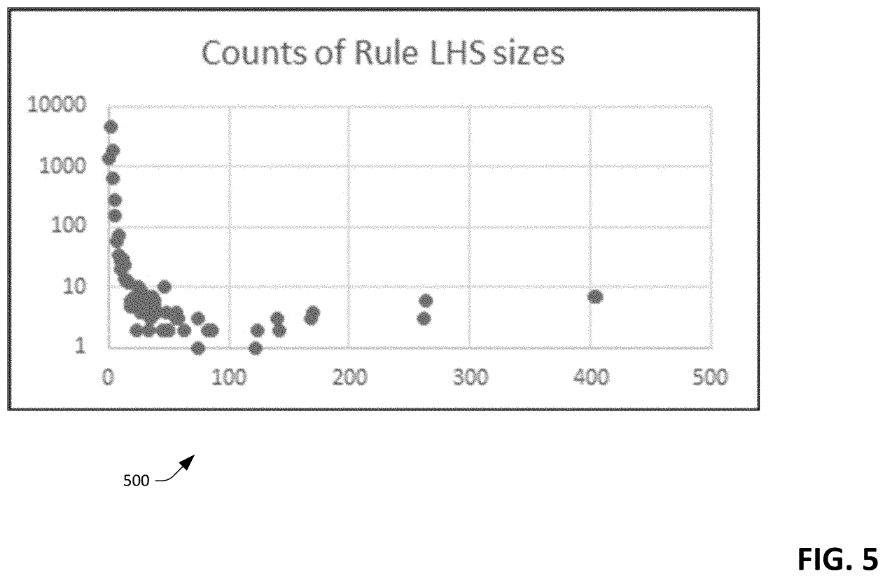

Referring now to FIG. 5, a plot 500 that illustrates a distribution of size of X is depicted. As illustrated in the plot 500, many of the X's include several items, with a weighted median of 14.

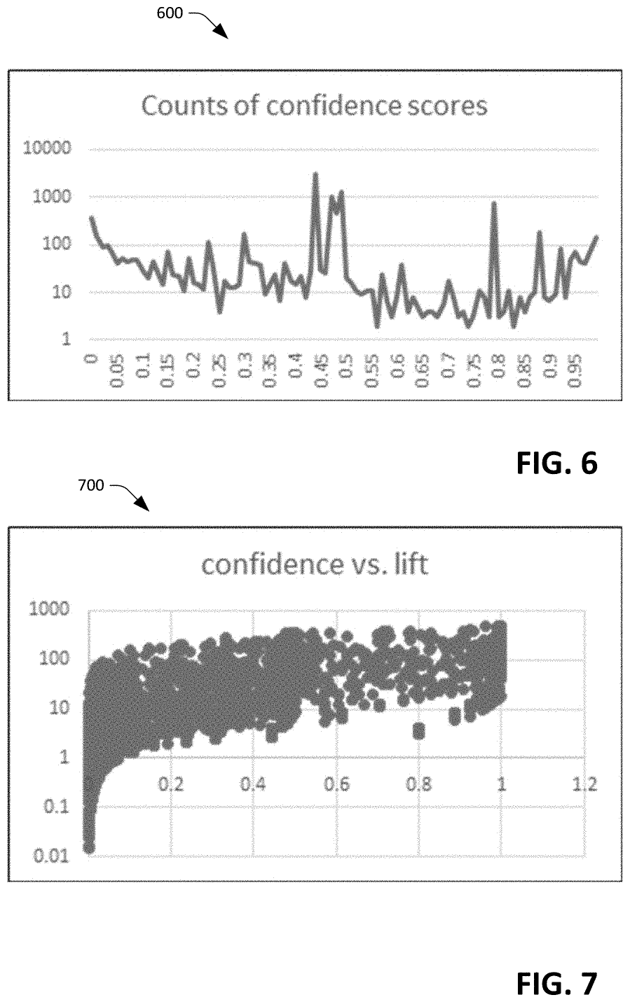

FIG. 6 is a plot 600 that illustrates distribution of confidence scores. It can be ascertained from the plot 600 that a high number of rules in the test have confidence scores at either end of the interval (0, 1) with a median of 0.4576.

FIG. 7 is a plot 700 that identifies the relationship between lift and confidence. In the plot 700, the vertical axis is scaled to log 10(lift).

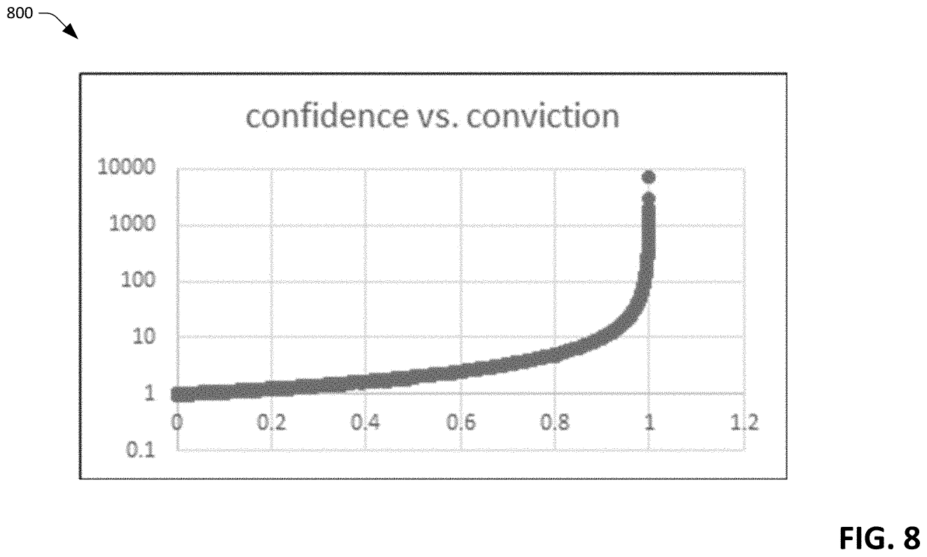

FIG. 8 is a plot 800 that illustrates a relationship between conviction and confidence. In the plot 800, the vertical axis is scaled to log 10(conviction).

The effectiveness of the association rules identifier system 122 and the rules applier system 124 was evidenced by a test that included 23 separate incidents. The test criterion was to check the fewest number of items (components) before pointing out a true responsible (root cause) for the incident. Overall, operation of the association rules identifier system 122 and the rules applier system compared favorably to an experienced engineer.

In addition, as referenced above, the technologies described herein can be employed in recommendation scenarios, such as in a scenario where a user has selected items that can be referenced as X_{α}, and the association rules identifier system 122 and the rules applier system 124 can identify and rank rules in connection with recommending a next item y_{α} for the user.

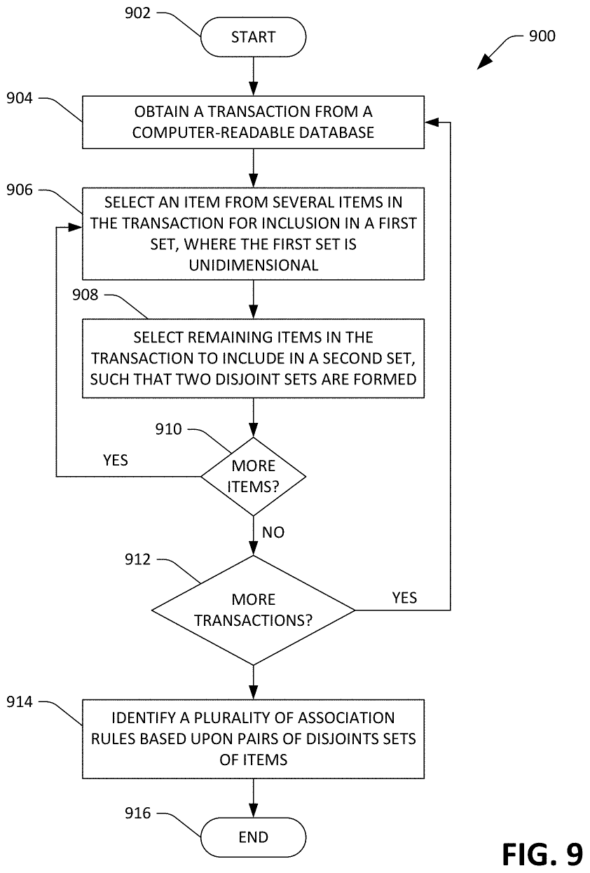

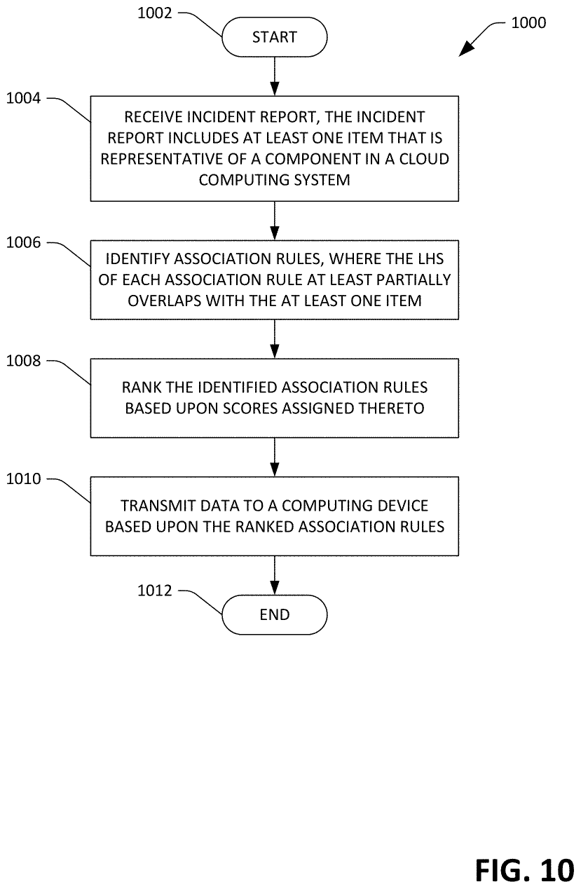

FIGS. 9 and 10 illustrate example methodologies relating to performing root cause analysis with respect to an incident referenced in an incident report generated by a cloud computing system. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Now referring solely to FIG. 9, a flow diagram illustrating an example method 900 for identifying association rules based upon transactions in a database is illustrated. The method 900 starts at 902, and at 904 a transaction is obtained from a computer-readable database that includes numerous transactions. The transaction includes several items, where the items are representative of components in a computing system, where the computing system is accessible to multiple computing devices by way of network connections. Hence, the computing system may be a public cloud computing system.

At 906, an item is selected from the several items to include in a first set, where the first set is unidimensional. At 908, remaining items in the transaction are selected for inclusion in a second set, such that two disjoint sets are created.

At 910, a determination is made as to whether there are more items in the transaction that have not been included in the first set. When there are more items that have not been included in the first set, the method 900 returns to 906. When there are not more items included in the first set, the method 900 proceeds to 912, where a determination is made as to whether there are additional transactions in the computer-readable database. When there are more transactions included in the computer-readable database, the method 900 returns to 904. When there are no more transactions in the computer-readable database, the method 900 proceeds to 914. At 914, a plurality of association rules are identified based upon pairs of disjoint sets of items. Each association rule maps one item to at least one other item, and the association rules are used in connection with performing troubleshooting in the computing system. The method 900 completes at 916.

With reference now to FIG. 10, an example method 1000 for applying an association rule to an incident report is illustrated. The method 1000 starts at 1002, and at 1004 an incident report is received, where the incident report includes at least one item that is representative of a component in a cloud computing system that has contributed to the incident report.

At 1006, association rules are identified, where the LHS of each of the identified association rules at least partially overlaps with the at least one item in the incident report.

At 1008, the association rules are ranked based upon scores assigned thereto. The scores may be scores for confidence, lift, conviction, support, relevance, or any suitable combination thereof.

It 1010, data is transmitted to a computing device of the cloud computing system based upon the ranked association rules. As indicated previously, the data transmitted to the computing device can include identifiers of components for an engineer to check in the cloud computing system when performing root cause analysis with respect to the incident report. In another example, the data may cause one or more components to be restarted. The method 1000 completes at 1012.

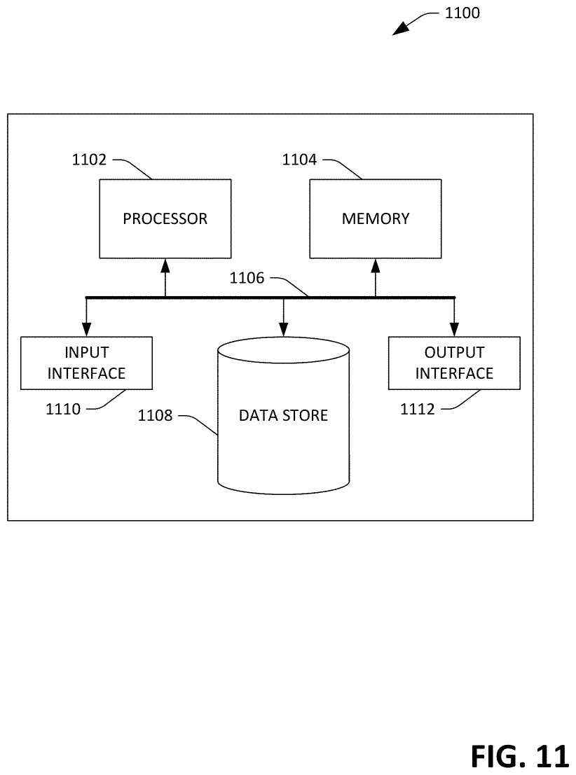

Referring now to FIG. 11, a high-level illustration of an exemplary computing device 1100 that can be used in accordance with the systems and methodologies disclosed herein is illustrated. For instance, the computing device 1100 may be used in a system that supports identifying association rules from a database of transactions. By way of another example, the computing device 1100 can be used in a system that identifies rules based upon a received incident report. The computing device 1100 includes at least one processor 1102 that executes instructions that are stored in a memory 1104. The instructions may be, for instance, instructions for implementing functionality described as being carried out by one or more components discussed above or instructions for implementing one or more of the methods described above. The processor 1102 may access the memory 1104 by way of a system bus 1106. In addition to storing executable instructions, the memory 1104 may also store transactions, rules, etc.

The computing device 1100 additionally includes a data store 1108 that is accessible by the processor 1102 by way of the system bus 1106. The data store 1108 may include executable instructions, transactions, incident reports, etc. The computing device 1100 also includes an input interface 1110 that allows external devices to communicate with the computing device 1100. For instance, the input interface 1110 may be used to receive instructions from an external computer device, from a user, etc. The computing device 1100 also includes an output interface 1112 that interfaces the computing device 1100 with one or more external devices. For example, the computing device 1100 may display text, images, etc. by way of the output interface 1112.

It is contemplated that the external devices that communicate with the computing device 1100 via the input interface 1110 and the output interface 1112 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1100 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1100 may be a distributed system. Thus, for instance, several devices may be in communication by way of a network connection and may collectively perform tasks described as being performed by the computing device 1100.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

From the foregoing it is ascertained that aspects described herein relate to performance of root cause analysis with respect to incident reports generated by a cloud computing system in accordance with the examples set forth below.

(A1) Some embodiments include a method performed by a computing system that is configured to assist with troubleshooting incidents that occur in a cloud computing system. The method includes obtaining an incident report, where the incident report includes several items that are representative of components of the cloud computing system that are reporting incidents during a window of time. The method also includes identifying association rules from amongst several association rules based upon the incident report, wherein each association rule in the association rules maps a respective set of items to a respective single item, wherein sets of items in the several association rules include at least one item that is also included in the several items of the incident report. The method additionally includes transmitting, based upon the identified association rules, a notification to a computing device of a technician for the cloud computing system, where the notification identifies the single items in the identified association rules as potential causes of the incidents reported by the components of the cloud computing system.

(A2) In some embodiments of the method of (A1), there are between 100,000 and 200,000 association rules in the several association rules.

(A3) In some embodiments of at least one of the methods of (A1)-(A2), the method also includes generating the association rules based upon transactions in a database, where the transactions are representative of incident reports, and further wherein the transactions include items that are representative of numerous components of the cloud computing system.

(A4) In some embodiments of at least one of the methods of (A1)-(A3), generating the association rules includes a) obtaining a transaction from the database, where the transaction includes several items, and further wherein the several items are representative of several components in the cloud computing system; b) selecting an item from the several items to include in a first set, wherein the first set is unidimensional; c) selecting remaining items in the several items to include in a second set, such that two disjoint sets are created; d) repeating acts b) and c) until each item in the several items has been included in a unidimensional set, such that multiple disjoint sets are created for the transaction; and e) repeating acts a)-d) for multiple transactions in the computer-readable database, such that multiple disjoint sets are created for each transaction in the multiple transactions, and further such that a plurality of disjoint sets of items are created, wherein the association rules are generated based upon the plurality of disjoint sets of items.

(A5) In some embodiments of at least one of the methods of (A1)-(A4), the association rules are identified based upon support values computed for the association rules.

(A6) In some embodiments of at least one of the methods of (A1)-(A5), the association rules are identified based upon confidence values computed for the association rules.

(A7) In some embodiments of at least one of the methods of (A1)-(A6), the association rules are identified based upon lift scores computed for the association rules.

(A8) In some embodiments of at least one of the methods of (A1)-(A7), the association rules are identified based upon conviction values computed for the association rules.

(B1) In another aspect, some embodiments include a method for performing root cause analysis with respect to an incident report generated by a cloud computing system. The method includes a) obtaining a transaction from a computer-readable database, where the transaction includes several items, and further where the several items are representative of components in a computing system, the computing system is accessible to computing devices by way of network connections; b) selecting an item from the several items to include in a first set, where the first set is unidimensional; c) selecting remaining items in the several items to include in a second set, such that two disjoint sets are created; d) repeating acts b) and c) until each item in the several items has been included in a unidimensional set, such that multiple disjoint sets are created for the transaction; e) repeating acts a)-d) for multiple transactions in the computer-readable database, such that multiple disjoint sets are created for each transaction in the multiple transactions, and further such that a plurality of pairs of disjoint sets of items are created; f) identifying a plurality of association rules for use in troubleshooting in the computing system, the plurality of association rules identified based upon the plurality of disjoint sets of items, wherein each association rule maps one item to at least one other item; g) subsequent to identifying the plurality of association rules, receiving at least one item that is representative of a first component in the computing system; h) identifying an association rule from the association rules based upon the at least one item, where the association rule maps the at least one item to another item that is representative of a second component in the computing system; and i) transmitting data to a computing device based upon the identified association rule, where the data indicates that the second component in the computing system is a root cause of an error associated with the first component in the computing system.

(B2) In some embodiments of the method of (B1), the data transmitted to the computing device comprises a recommendation to an engineer to inspect the second component in the computing system.

(B3) In some embodiments of the method of at least one of (B1)-(B2), identifying the plurality of association rules includes computing a confidence value for the association rule. Identifying the plurality of association rules further includes comparing the confidence value with a threshold, where the association rule is included in the plurality of association rules based upon the confidence value being greater than the threshold.

(B4) In some embodiments of the method of at least one of (B1)-(B3), identifying the plurality of association rules includes computing a support value for the association rule. Identifying the plurality of association rules also includes comparing the support value with a threshold, where the association rule is included in the plurality of association rules based upon the confidence value being greater than the threshold.

(B5) In some embodiments of the method of (B4), the association rule is identified from the association rules based upon the support value computed for the association rule.

(B6) In some embodiments of the method of at least one of (B1)-(B5), the method further includes computing a value for lift for the association rule, where the association rule is identified from the association rules based upon the value for lift computed for the association rule.

(B7) In some embodiments of the method of at least one of (B1)-(B6), the method also includes computing a value for conviction for the association rule, where the association rule is identified from the association rules based upon the value for conviction computed for the association rule.

(B8) In some embodiments of the method of at least one of (B1)-(B7), the method also includes computing a value for relevance for the association rule, where the value for relevance is based upon the at least one item being included in the association rule, and further where the association rule is identified from the association rules based upon the value for relevance computed for the association rule.

(B9) In some embodiments of the method of at least one of (B1)-(B8), there are between 100,000 and 2,000,000 transactions in the multiple transactions.

(B10) In some embodiments of the method of at least one of (B1)-(B9), the data transmitted to the computing device causes the second component to be restarted.

(C1) In another aspect, some embodiments include a computing system that includes a processor and memory, where the memory stores instructions that, when executed by the processor, cause the processor to perform a method described herein (e.g., any of the methods of (A1)-(A8) and/or (B1)-(B10)).

(D1) In yet another aspect, some embodiments include a computer-readable storage medium that includes instructions that, when executed by a processor, cause the processor to perform a method described herein (e.g., any of the methods of (A1)-(A8) and/or (B1)-(B10)).

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system comprising:
a processor; and
memory storing instructions that, when executed by the processor, cause the processor to perform acts comprising:
a) obtaining a transaction from a computer-readable database, wherein the transaction includes several items, and further wherein the several items are representative of components in a computing system, the computing system is accessible to computing devices by way of network connections;
b) selecting an item from the several items to include in a first set, wherein the first set is unidimensional;
c) selecting remaining items in the several items to include in a second set, such that two disjoint sets are created;
d) repeating acts b) and c) until each item in the several items has been included in a unidimensional set, such that multiple disjoint sets are created for the transaction;
e) repeating acts a)-d) for multiple transactions in the computer-readable database, such that multiple disjoint sets are created for each transaction in the multiple transactions, and further such that a plurality of pairs of disjoint sets of items are created;
f) identifying a plurality of association rules for use in troubleshooting in the computing system, the plurality of association rules identified based upon the plurality of disjoint sets of items, wherein each association rule maps one item to at least one other item;
g) subsequent to identifying the plurality of association rules, receiving at least one item that is representative of a first component in the computing system;
h) identifying an association rule from the association rules based upon the at least one item, wherein the association rule maps the at least one item to another item that is representative of a second component in the computing system; and
i) transmitting data to a computing device based upon the identified association rule, wherein the data indicates that the second component in the computing system is a root cause of an error associated with the first component in the computing system.

2. The computing system of claim 1, wherein the data transmitted to the computing device comprises a recommendation to an engineer to inspect the second component in the computing system.

3. The computing system of claim 1, wherein identifying the plurality of association rules comprises:
computing a confidence value for the association rule; and
comparing the confidence value with a threshold, wherein the association rule is included in the plurality of association rules based upon the confidence value being greater than the threshold.

4. The computing system of claim 1, wherein identifying the plurality of association rules comprises:
computing a support value for the association rule; and
comparing the support value with a threshold, wherein the association rule is included in the plurality of association rules based upon the confidence value being greater than the threshold.

5. The computing system of claim 4, wherein the association rule is identified from the association rules based upon the support value computed for the association rule.

6. The computing system of claim 1, further comprising:
computing a value for lift for the association rule, wherein the association rule is identified from the association rules based upon the value for lift computed for the association rule.

7. The computing system of claim 1, further comprising:
computing a value for conviction for the association rule, wherein the association rule is identified from the association rules based upon the value for conviction computed for the association rule.

8. The computing system of claim 1, further comprising:
computing a value for relevance for the association rule, wherein the value for relevance is based upon the at least one item being included in the association rule, and further wherein the association rule is identified from the association rules based upon the value for relevance computed for the association rule.

9. The computing system of claim 1, wherein there are between 100,000 and 2,000,000 transactions in the multiple transactions.

10. The computing system of claim 1, wherein the data transmitted to the computing device causes the second component to be restarted.

11. A method performed by a computing system that is configured to assist with troubleshooting incidents that occur in a cloud computing system, the method comprising:
obtaining an incident report, wherein the incident report includes several items that are representative of components of the cloud computing system that are reporting incidents during a window of time;
identifying association rules from amongst several association rules based upon the incident report, wherein each association rule in the association rules maps a respective set of items to a respective single item, wherein sets of items in the several association rules include at least one item that is also included in the several items of the incident report; and
based upon the identified association rules, transmitting a notification to a computing device of a technician for the cloud computing system, the notification identifies the single items in the identified association rules as potential causes of the incidents reported by the components of the cloud computing system.

12. The method of claim 11, wherein there are between 100,000 and 200,000 association rules in the several association rules.

13. The method of claim 11, further comprising generating the association rules based upon transactions in a database, wherein the transactions are representative of incident reports, and further wherein the transactions include items that are representative of numerous components of the cloud computing system.

14. The method of claim 13, wherein generating the association rules comprises:
a) obtaining a transaction from the database, wherein the transaction includes several items, and further wherein the several items are representative of several components in the cloud computing system;
b) selecting an item from the several items to include in a first set, wherein the first set is unidimensional;
c) selecting remaining items in the several items to include in a second set, such that two disjoint sets are created;
d) repeating acts b) and c) until each item in the several items has been included in a unidimensional set, such that multiple disjoint sets are created for the transaction;
e) repeating acts a)-d) for multiple transactions in the computer-readable database, such that multiple disjoint sets are created for each transaction in the multiple transactions, and further such that a plurality of disjoint sets of items are created, wherein the association rules are generated based upon the plurality of disjoint sets of items.

15. The method of claim 11, wherein the association rules are identified based upon support values computed for the association rules.

16. The method of claim 11, wherein the association rules are identified based upon confidence values computed for the association rules.

17. The method of claim 11, wherein the association rules are identified based upon lift scores computed for the association rules.

18. The method of claim 11, wherein the association rules are identified based upon conviction values computed for the association rules.

19. A computer-readable storage medium comprising instructions that, when executed by a processor, cause the processor to perform acts comprising:
a) obtaining a transaction from a computer-readable database, wherein the transaction includes several items, and further wherein the several items are representative of components in a computing system, the computing system is accessible to computing devices by way of network connections;
b) selecting an item from the several items to include in a first set, wherein the first set is unidimensional;
c) selecting remaining items in the several items to include in a second set, such that two disjoint sets are created;
d) repeating acts b) and c) until each item in the several items has been included in a unidimensional set, such that multiple disjoint sets are created for the transaction;
e) repeating acts a)-d) for multiple transactions in the computer-readable database, such that multiple disjoint sets are created for each transaction in the multiple transactions, and further such that a plurality of disjoint sets of items are created;
f) identifying a plurality of association rules for use in troubleshooting in the computing system, the plurality of association rules identified based upon the plurality of disjoint sets of items, wherein each association rule maps one item to at least one other item;
g) subsequent to identifying the plurality of association rules, receiving at least one item that is representative of a first component in the computing system;
h) identifying an association rule from the association rules based upon the at least one item, wherein the association rule maps the at least one item to another item that is representative of a second component in the computing system; and
i) transmitting data to a computing device based upon the identified association rule, wherein the data indicates that the second component in the computing system is a root cause of an error associated with the first component in the computing system.

20. The computer-readable storage medium of claim 19, wherein the data transmitted to the computing device comprises a recommendation to an engineer to inspect the second component in the computing system.
